(19) United States
(12) Patent Application Publication
(10) Pub. No.: US 2026/0183806 A1
(43) Pub. Date: Jul. 2, 2026

(54) METHODS AND SYSTEMS FOR ERODING AND PREVENTING DEPOSITS WITHIN VESSELS

(71) Applicant: Saudi Arabian Oil Company, Dhahran (SA)

(72) Inventors: Tariq A. Khathami, Dammam (SA); Abdulrahman E. Sayed, Dammam (SA); Abdullah M. Salma, Dhahran (SA); Mohammed A. Alshahrani, Dammam (SA)

(73) Assignee: Saudi Arabian Oil Company, Dhahran (SA)

(21) Appl. No.: 19/008,010

(22) Filed: Jan. 2, 2025

(51) Int. Cl. B08B 9/04

(52) U.S. Cl. CPC B08B 9/04

(57) ABSTRACT

A flow redirecting device is disclosed having a telescoping mechanism including an inlet telescoping member and an end telescoping member. The inlet telescoping member is an annular wall having a first proximal diameter and a first distal diameter less than the first proximal diameter, and the end telescoping member has an open end and a closed end, the open end having a second proximal diameter less than the first proximal diameter. The telescoping mechanism has a retracted configuration in which the end telescoping member is nested inside of the inlet telescoping member, and the telescoping mechanism has an extended configuration in which the inlet telescoping member and the end telescoping member are arranged end to end to define a flow path that narrows from the first proximal diameter of the inlet telescoping member to the second proximal diameter of the end telescoping member.

### FIELD

The present disclosure relates to methods and systems for detection and removal of solid deposits from chemical processing equipment through the use of flow redirecting devices, artificial eroding objects, or both.

### TECHNICAL BACKGROUND

Solid deposits may accumulate on the inner surface of vessels or lines of chemical processing systems such as located in hydrocarbon refineries, pipelines, petrochemical industries, power plants, desalination plants, or other chemical processing facility. Moreover, accumulation of the solid deposits may result in an increase in pressure drop and a decrease in heat transfer, decreasing the efficiency of the system. The solid deposits may be removed through pressurized water or other mechanical tools. The solid deposits may also be removed through the use of chemical solutions. However, typical methods using mechanical tools to remove the accumulation of solid deposits on the inner surface of vessels and lines require a full shut down and isolation of the processing system, which is time-consuming and costly. Typical methods using chemical solutions require very high temperatures and do not result in the removal of all solid deposits. Moreover, chemical processing systems may include vessels or lines that span or hang hundreds of feet in the air, making human inspection or cleaning difficult or impossible.

### SUMMARY

Accordingly, there is an ongoing need for systems and methods for chemical processing and removal of solid deposits from interior surfaces of chemical processing units. Additionally, there may be an ongoing need for automatically determining or predicting a location of the accumulation of solid deposits and operating the system through a machine learning module.

According to embodiments of the present disclosure, a flow redirecting device is disclosed having a telescoping mechanism including an inlet telescoping member and an end telescoping member. The inlet telescoping member is an annular wall having a first proximal diameter and a first distal diameter less than the first proximal diameter, and the end telescoping member has an open end and a closed end, the open end having a second proximal diameter less than the first proximal diameter. The telescoping mechanism has a retracted configuration in which the end telescoping member is nested inside of the inlet telescoping member, and the telescoping mechanism has an extended configuration in which the inlet telescoping member and the end telescoping member are arranged end to end to define a flow path that narrows from the first proximal diameter of the inlet telescoping member to the second proximal diameter of the end telescoping member. The end telescoping member has an aperture defined therein, wherein the aperture is in fluid communication with the flow path defined by the inlet telescoping member and has a cross-sectional area that is less than a cross-sectional area of the open end of the end telescoping member. The device further includes an extending arm coupled to the inlet telescoping member and the end telescoping member, wherein the extending arm is configured to transition the telescoping mechanism between the retracted configuration and the extended configuration and a plate coupled to the inlet telescoping member and constructed of a ferromagnetic metal.

According to embodiments of the present disclosure, a method for eroding a deposit within a vessel is disclosed. The method includes the steps of expanding a flow redirecting device within the vessel, the flow redirecting device including a telescoping mechanism comprising an inlet telescoping member and an end telescoping member. The inlet telescoping member is an annular wall having a first proximal diameter and a first distal diameter less than the first proximal diameter. The end telescoping member has an open end and a closed end, the open end having a second proximal diameter less than the first proximal diameter. The telescoping mechanism has a retracted configuration in which the end telescoping member is at least partially nested inside of the inlet telescoping member. The telescoping mechanism has an extended configuration in which the inlet telescoping member and the end telescoping member are arranged end to end to define a flow path that narrows from the first proximal diameter of the inlet telescoping member to the second proximal diameter of the end telescoping member. The end telescoping member has an aperture defined therein and is in fluid communication with the flow path defined by the inlet telescoping member and has a cross-sectional area that is less than a cross-sectional area of the open end of the end telescoping member. The flow redirecting device further includes an extending arm coupled to the inlet telescoping member and the end telescoping member, wherein the extending arm selectively transitions the telescoping mechanism between the retracted configuration and the extended configuration and a plate coupled to the inlet telescoping member and constructed of a ferromagnetic metal. The method further includes directing the aperture towards the deposit formed on an inner surface of the vessel, disposing one or more eroding objects within the vessel such that the eroding objects enter the fluid flow within the vessel, redirecting a portion of a fluid and eroding objects flowing through the vessel into the inlet telescoping member and out of the aperture, wherein a shape and size of the end telescoping member relative to the inlet telescoping member causes the fluid to increase in velocity, and eroding the deposit with a flow out of the aperture.

### BRIEF DESCRIPTION OF THE DRAWINGS

The following detailed description of specific embodiments of the present disclosure can be best understood when read in conjunction with the following drawings, in which like structure may be indicated with like reference numerals and in which:

FIG. 1 schematically depicts a perspective view of a flow redirecting device having a telescopic mechanism in an extended configuration, according to embodiments shown and described in the present disclosure;

FIG. 2 schematically depicts a front view of the flow redirecting device of FIG. 1 in a retracted configuration, according to embodiments shown and described in the present disclosure;

FIG. 3A schematically depicts a side view of the flow redirecting device of FIG. 2 in a retracted position, according to embodiments shown and described in the present disclosure;

FIG. 3B schematically depicts a side view of the flow redirecting device of FIG. 1 in a partially extended configuration, according to embodiments shown and described in the present disclosure;

FIG. 3C schematically depicts a side view of the flow redirecting device of FIG. 1 in a fully extended configuration, according to embodiments shown and described in the present disclosure;

FIG. 4 schematically depicts a perspective view of a portion of the flow redirecting device of FIG. 1 having an aperture to direct an eroding object toward a deposit solid within a vessel, according to embodiments shown and described in the present disclosure;

FIG. 5 schematically depicts a side perspective view of a flow redirecting device having a telescopic mechanism in a retracted configuration, the flow redirecting device having one or more cavities defined therein, according to embodiments shown and described in the present disclosure;

FIG. 6A schematically depicts a side view of a robot for guiding the flow redirecting device of FIG. 1 through a vessel, according to embodiments shown and described in the present disclosure;

FIG. 6B schematically depicts a side view of the robot for guiding a flow redirecting device through a metallic vessel of FIG. 6A with the flow redirecting device in a second position, according to embodiments shown and described in the present disclosure; and

FIG. 7 schematically depicts a distributed computing environment with a control system communicatively coupled to a plurality of components, according to embodiments shown and described in the present disclosure.

The drawings are not to scale and proportions may be exaggerated for the purposes of illustrating the concepts of the present disclosure.

### DETAILED DESCRIPTION

Embodiments of the present disclosure are described in the detailed description, which follows. The present disclosure may be directed to systems and processes for chemical processing. In particular, the present disclosure is related to systems and processes for removing solid deposits from interior surfaces of hollow structures of chemical processing units.

As used throughout the present disclosure, the term “axial” refers to a direction that is substantially parallel to the central axis A of the hollow structure, unless otherwise specified.

As used throughout the present disclosure, the term “angular” refers to a direction that is around a circumference of the hollow structure, such as around the outer perimeter P of the hollow structure.

As used throughout the present disclosure, the term “radial” refers to a direction that is perpendicular to and outward from the central axis A of the hollow structure.

As used throughout the present disclosure, “solid deposits” refer to salts, coke, asphaltenes, carbon, polynuclear aromatic compounds, solid contaminants, or any other solid-phase byproduct of a hydrocarbon chemical reaction or hydrocarbon processing that may be deposited on an inner surface of the hollow structure.

As used throughout the present disclosure, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation

Systems for chemical processing, such as but not limited to petrochemical reactors, heaters, heat exchangers, transfer piping, catalyst regenerators, separation units, holding tanks, hydrocarbon pipelines, distillation columns, furnaces, or other chemical processing units may include hollow structures, such as but not limited to pipes, tanks, pressure vessels, or other hollow structures, that have internal surfaces that contact process fluids during chemical processing. During operation of the systems for chemical processing, the hollow structures of the system can accumulate solid deposits on the inner walls of hollow structures. Such solid deposits may include but are not limited to coke, salts, asphaltenes, polynuclear aromatic compounds, solid contaminants, other solid-phase materials, or combinations of these. Accumulation of the solid deposits on the inner walls may lead to increased pressure drop, decreased heat transfer, restricted flow, or combinations of these conditions, which may decrease the efficiency of the system, lead to poor product quality, or both.

Systems and methods have been developed to monitor the accumulation of and removal of the solid deposits in such systems for chemical processes. These conventional methods of removing solid deposits involve the use of mechanical tools or chemical solutions to monitor the accumulation of and remove the solid deposits. However, conventional mechanical tools require full shut down and isolation of the targeted system, and utilization of chemical solutions requires very high temperatures and does not remove solid deposits with stronger bonds, such as hard coke, that require more dissociation energy to break. Use of mechanical tools often require the use of human intervention, making removal of solid deposits difficult. Use of chemical solutions can also result in the corrosion of the hollow structure as well as other equipment and piping systems. Use of chemical solutions can also require partial or complete shutdown of the hollow structure and associated systems, such as for reactors and piping for fluidized catalytic cracking systems operated at reaction temperatures in excess of 400° C.

The present disclosure solves these problems by providing flow redirecting devices and artificial eroding objects that can artificially erode the solid deposits that have accumulated in such systems while allowing the systems to remain operative, or otherwise active.

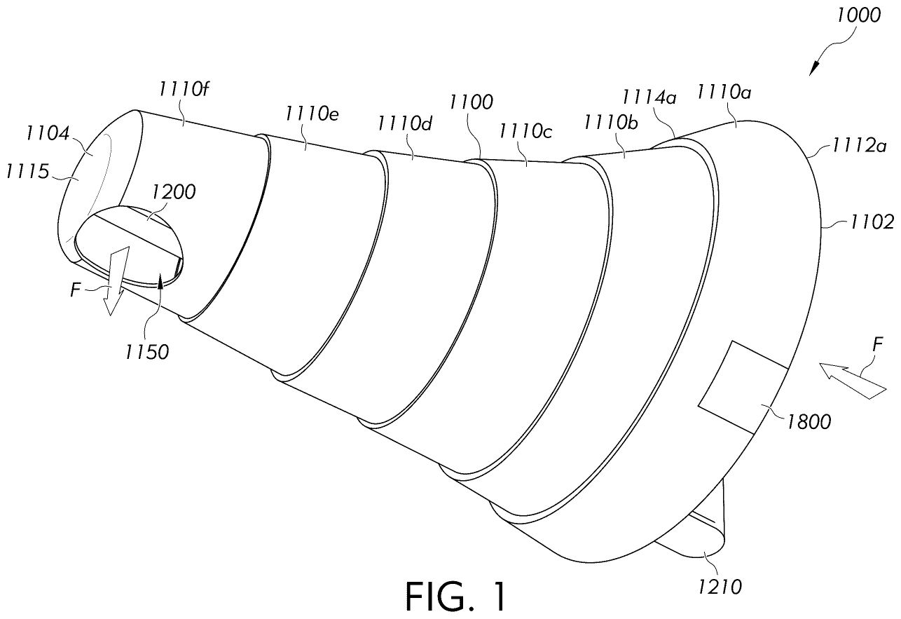

FIG. 1 depicts a flow redirecting device 1000 for use in accelerating and redirecting a flow F of materials through a particular vessel. In particular, the flow redirecting device 1000 can be used to redirect the flow F of content in a desired angle toward a desired portion, such as a wall, of a vessel or pipeline creating a shear force that erodes the solid deposits away from the wall. In instances, the vessel can include a tube, a pipeline, a tank, a reactor, a column, or the like. Such vessels can include a protective coating on an interior wall thereof. In instances, the materials can include a fluid or any flowable material, for example. As used throughout the present disclosure, the term “fluid” includes liquids, gases, or both and may include solids in combination with the liquids, gases, or both.

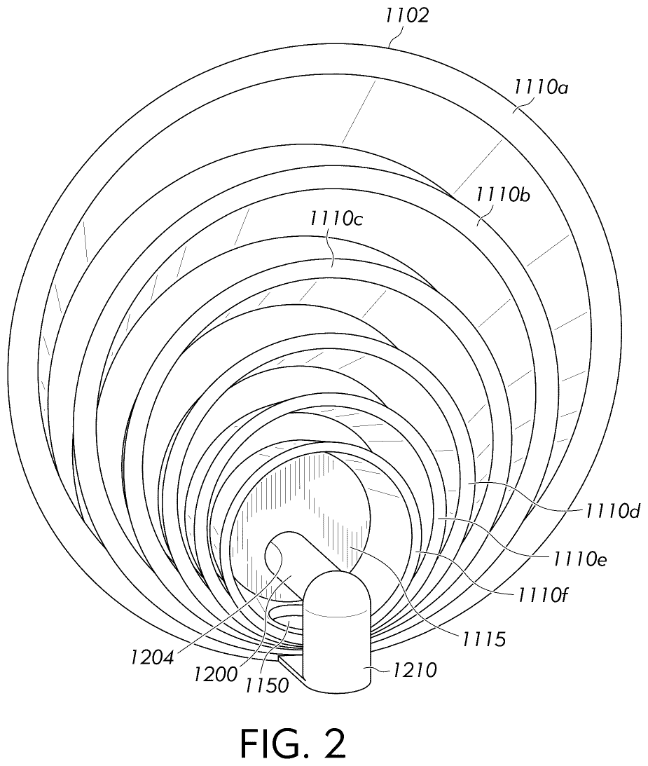

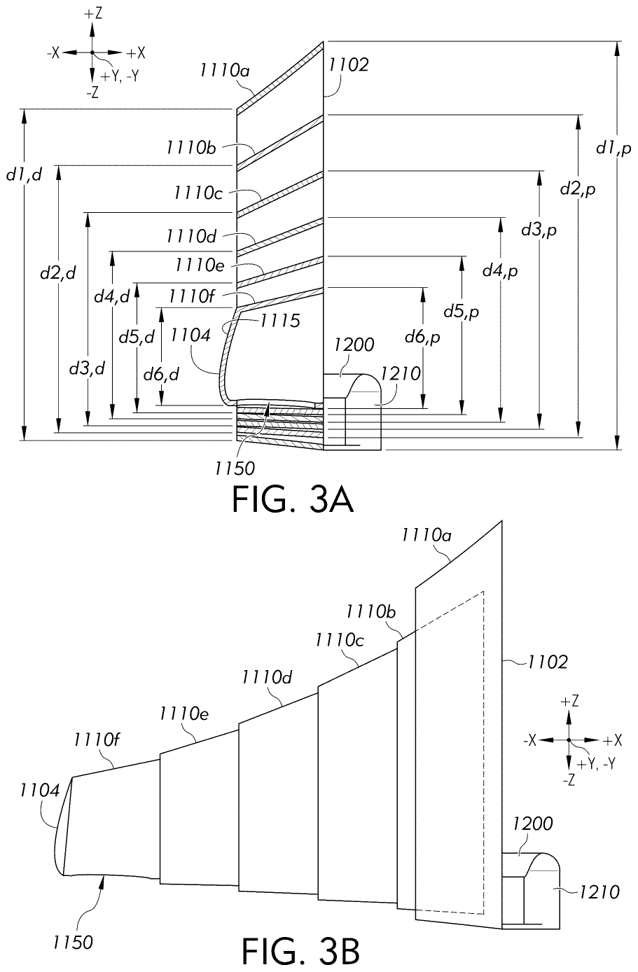

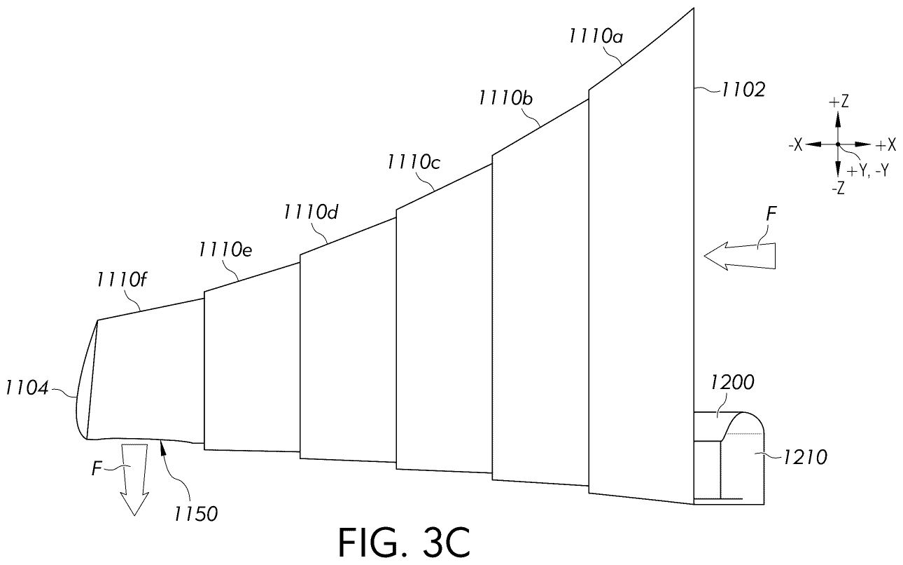

Introducing the flow redirecting device 1000 into the vessel narrows the diameter of the vessel in a particular region thereby causing flowing content velocity to increase in order to maintain a constant flowrate therethrough. In addition to causing the flowing content velocity to increase, redirecting the flow of the content toward a wall of the vessel causes a disturbance to a laminar flow regime at the wall of the vessel and can change the laminar flow to a turbulent flow, thereby increasing an erosion rate of unwanted solid deposits, for example. Additionally, the flow may be directed at an angle to the wall of the vessel to produce the shear forces between the fluids and the solid deposits. The flow redirecting device 1000 includes a telescoping mechanism 1100 having a plurality of telescoping members 1110 coupled to one another. The flow redirecting device 1000, including the telescoping mechanism 1100 and the plurality of telescoping members 1110 are comprised of one or more non-ferromagnetic materials. The telescoping mechanism 1100 is selectively transitioned between a retracted configuration as shown in FIGS. 2 and 3A and a plurality of extended configurations as shown in FIGS. 1, 3B, and 3C, for example.

As depicted in FIGS. 1-3C, the plurality of telescoping members 1110 may include an inlet telescoping member 1110a and an end telescoping member 1110f. In embodiments, the telescoping mechanism 1100 may also include one or a plurality of intermediate telescoping members 1110b, 1110c, 1110d, and 1110e. At least a portion of the end telescoping member 1110f is nested within the inlet telescoping member 1110a when the plurality of telescoping members 1110 are in a retracted configuration. As the plurality of telescoping members 1110 transitions to an extended configuration, the end telescoping member 1110f is the first telescoping member 1110 to move relative to the inlet telescoping member 1110a. After the end telescoping member 1110f begins to move relative to the inlet telescoping member 1110a, the intermediate telescoping members 1110b, 1110c, 1110d, and 1110e follow in a sequential manner.

The plurality of telescoping members 1110 includes an inlet telescoping member 1110a.

The plurality of telescoping members 1110 includes an end telescoping member 1110f. The distal end 1104 of the telescoping mechanism 1100 is closed. As such, the distal end of the distal-most telescoping member, such as end telescoping member 1110f, is closed while all of the distal ends of the remaining plurality of telescoping members 1110a, 1110b, 1110c, 1110d, 1110e are open. Stated another way, the distal end of the inlet telescoping member 1110a defines an open passage, thereby allowing the flow F of materials therethrough and/or allowing one or more distal telescoping members to slide therethrough. The closed distal end 1104 of the distal-most telescoping member, which in the depicted telescoping mechanism 1100 is the end telescoping member 1110f, includes an end wall 1115.

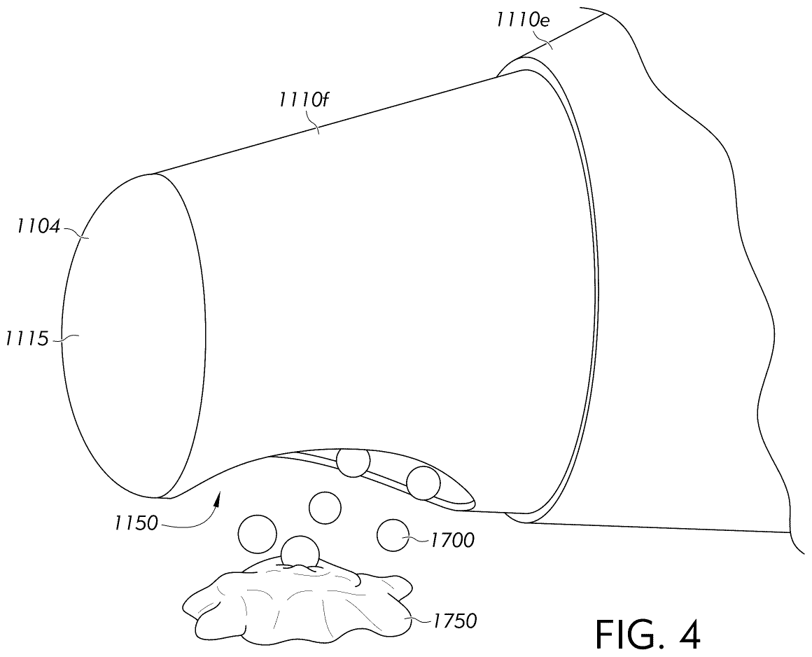

As shown in FIG. 4, an aperture 1150 is defined through a portion of the distal-most telescoping member, such as the end telescoping member 1110f. The aperture 1150 is a through hole so as to allow content to pass in a directed manner therethrough. Stated another way, the aperture 1150 is in fluid communication with the flow path defined by the inlet telescoping member 1110a. In instances, the aperture 1150 is defined on a base, or sidewall, of the end telescoping member 1110f. The aperture 1150 can be defined along a width of the end telescoping member 1110f; however, the size of the aperture 1150 can be selected for a particular use. In instances, the aperture 1150 is defined by a cross-sectional area that is less than a cross-sectional area of the open, proximal end of the end telescoping member 1110f.

The aperture 1150 serves as an exit point for the content to flow F out of the flow redirecting device 1000. A diameter of the aperture 1150 is less than the various diameters along the telescoping mechanism 1100. As such, the content flows out of the aperture 1150 at an accelerated, or otherwise increased, rate. The flow redirecting device 1000 can be selectively oriented to align the aperture 1150 adjacent an undesirable deposit 1750, such as a solid deposit, within a vessel so as to direct the outflow F of content toward the deposit 1750.

The plurality of telescoping members 1110 may include one or more intermediate telescoping members positioned intermediate the inlet telescoping member 1110a and the end telescoping member 1110f. As depicted in FIGS. 1-3C, the one or more intermediate telescoping members includes a second telescoping member 1110b, a third telescoping member 1110c, a fourth telescoping member 1110d, and a fifth telescoping member 1110e. While the depicted telescoping mechanism 1100 includes six telescoping members 1110a, 1110b, 1110c, 1110d, 1110e, 1110f, the telescoping mechanism 1100 can include any suitable number of telescoping members. In embodiments, the telescoping mechanism 1100 can include less than six telescoping members, such as two, three, four, or five telescoping members. In embodiments, the telescoping mechanism 1100 can include more than six telescoping members, such as seven, eight, nine, ten, or more than 10 telescoping members.

The depicted telescoping mechanism 1100 is conical in geometry; however, any suitable geometry, or profile, of the telescoping mechanism 1100 is envisioned, as long as the telescoping members are capable of nesting within one another in the retracted configuration and extending to the extended configuration during operation. The conical geometry is formed as a result of annular telescoping members 1110a, 1110b, 1110c, 1110d, 1110e, 1110f. Stated another way, each of the plurality of telescoping members 1110a, 1110b, 1110c, 1110d, 1110e, 1110f has a tapered, circular profile. In alternative instances, the plurality of telescoping members 1110a, 1110b, 1110c, 1110d, 1110e, 1110f can have any suitable geometry, such as ovular, square, rectangular, or other geometry, for example.

The flow redirecting device 1000 is sized to be received within a particular vessel. As such, the plurality of telescoping members 1110a, 1110b, 1110c, 1110d, 1110e, 1110f of the telescoping mechanism 1100 is sized to be received within the particular vessel. Stated another way, a diameter of the telescoping mechanism 1100 is less than a diameter of the particular vessel so as to prevent the flow redirecting device 1000 from clogging, or otherwise becoming stuck within, the vessel, for example. In instances, a diameter of the telescoping mechanism 1100 does not exceed half of the diameter of the vessel.

As shown in FIG. 3A, the inlet telescoping member 1110a is defined by a first proximal diameter d_{1,p} and a first distal diameter d_{1,d}. The first proximal diameter d_{1,p} and the first distal diameter d_{1,d} are defined between opposing points on an external surface of the inlet telescoping member 1110a. The first proximal diameter d_{1,p} is greater than the first distal diameter d_{1,d}. The second telescoping member 1110b is defined by a second proximal diameter d_{2,p} and a second distal diameter d_{2,d}. The second proximal diameter d_{2,p} and the second distal diameter d_{2,d} are defined between opposing points on an external surface of the second telescoping member 1110b. Notably, the second proximal diameter d_{2,p} is greater than a distal diameter defined between opposing points on an internal surface of the inlet telescoping member 1110a to facilitate the telescoping functionality of the flow redirecting device 1000. The second proximal diameter d_{2,p} is greater than the second distal diameter d_{2,d}. The third telescoping member 1110c is defined by a third proximal diameter d_{3,p} and a third distal diameter d_{3,d}. The third proximal diameter d_{3,p} and the third distal diameter d_{3,d} are defined between opposing points on an external surface of the third telescoping member 1110c. Notably, the third proximal diameter d_{3,p} is greater than a distal diameter defined between opposing points on an internal surface of the second telescoping member 1110b to facilitate the telescoping functionality of the flow redirecting device 1000. The third proximal diameter d_{3,p} is greater than the third distal diameter d_{3,d}. The fourth telescoping member 1110d is defined by a fourth proximal diameter d_{4,p} and a fourth distal diameter d_{4,d}. The fourth proximal diameter d_{4,p} and the fourth distal diameter d₄, are defined between opposing points on an external surface of the fourth telescoping member 1110d. Notably, the fourth proximal diameter d₄.p is greater than a distal diameter defined between opposing points on an internal surface of the third telescoping member 1110c to facilitate the telescoping functionality of the flow redirecting device 1000. The fourth proximal diameter d_{4,p} is greater than the fourth distal diameter d_{4,d}. The fifth telescoping member 1110e is defined by a fifth proximal diameter d_{5,p} and a fifth distal diameter d_{5,d}. The fifth proximal diameter d_{5,p} and the fifth distal diameter d_{5,d} are defined between opposing points on an external surface of the fifth telescoping member 1110e. Notably, the fifth proximal diameter d_{5,p} is greater than a distal diameter defined between opposing points on an internal surface of the fourth telescoping member 1110d to facilitate the telescoping functionality of the flow redirecting device 1000. The fifth proximal diameter d_{5,p} is greater than the fifth distal diameter d_{5,d}. The end telescoping member 1110f is defined by a sixth proximal diameter d_{6,p} and a sixth distal diameter d_{6,d}. The sixth proximal diameter d_{6,p} and the sixth distal diameter d_{6,d} are defined between opposing points on an external surface of the end telescoping member 1110f. Notably, the sixth proximal diameter d_{6,p} is greater than a distal diameter defined between opposing points on an internal surface of the fifth telescoping member 1110e to facilitate the telescoping functionality of the flow redirecting device 1000. The sixth proximal diameter d_{6,p} is greater than the sixth distal diameter d_{6,d}. In instances, a ratio of the first proximal diameter d_{1,p} to the sixth distal diameter d_{6,d} is 1.5:20. In instances, the ratio of the first proximal diameter d_{1,p} to the sixth distal diameter d_{6,d} is 3:10. The conical geometry of the depicted telescoping mechanism 1100 results in a flow path of content through the telescoping mechanism 1100, where the flow path narrows in a direction from the first proximal diameter d_{1,p} toward the sixth proximal diameter d_{6,p}.

As described herein, each of the plurality of telescoping members 1110a, 1110b, 1110c, 1110d, 1110e, 1110f include a geometry such that one or more distal telescoping members can be nested, or otherwise housed, within one or more proximal telescoping members when the telescoping mechanism 1100 is in a retracted configuration, for example. More specifically, an interior cavity defined by the inlet telescoping member 1110a is sized to slidably receive the second telescoping member 1110b within the inlet telescoping member 1110a and allow the second telescoping member 1110b to slide between the retracted configuration and the extended configuration. An interior cavity defined by the second telescoping member 1110b is sized to slidably receive the third telescoping member 1110c within the second telescoping member 1110b and allow the third telescoping member 1110c to slide between the retracted configuration and the extended configuration. An interior cavity defined by the third telescoping member 1110c is sized to slidably receive the fourth telescoping member 1110d within the third telescoping member 1110c and allow the fourth telescoping member 1110d to slide between the retracted configuration and the extended configuration. An interior cavity defined by the fourth telescoping member 1110d is sized to slidably receive the fifth telescoping member 1110e within the fourth telescoping member 1110d and allow the fifth telescoping member 1110e to slide between the retracted configuration and the extended configuration. An interior cavity defined by the fifth telescoping member 1110e is sized to slidably receive the end telescoping member 1110f within the fifth telescoping member 1110e and allow the end telescoping member 1110f to slide between the retracted configuration and the extended configuration As such, in the retracted configuration, the second telescoping member 1110b, third telescoping member 1110c, fourth telescoping member 1110d, fifth telescoping member 1110e, and end telescoping member 1110f are nested within the interior cavity defined by the inlet telescoping member 1110a.

In instances, the plurality of telescoping members 1110a, 1110b, 1110c, 1110d, 1110e, 1110f are slidable relative to one another. More specifically, the second telescoping member 1110b can slide relative to the inlet telescoping member 1110a along a track defined along a sidewall of the inlet telescoping member 1110a. In such instances, the second telescoping member 1110b can include an attachment feature sized to slidably engage the track. In instances, a coupling member can facilitate a sliding of the second telescoping member 1110b relative to the inlet telescoping member 1110a. In instances, the proximal diameter d_{2,p} of the second telescoping member 1110b is greater than the distal diameter d_{1,d} of the inlet telescoping member 1110a such that the second telescoping member 1110b is prevented from distally translating out of, or otherwise disengaging from, the first telescoping member, when moving from the retracted configuration to the extended configuration. In other instances, the proximal diameter d_{2,p} of the second telescoping member 1110b is less than the distal diameter d_{1,d} of the inlet telescoping member 1110a.

In instances, the plurality of telescoping members 1110a, 1110b, 1110c, 1110d, 1110e, 1110f are sized such that the plurality of telescoping members 1110a, 1110b, 1110c, 1110d, 1110e, 1110f are oriented in a substantially concentric manner with respect to one another in the retracted and/or extended configurations. In other instances, the plurality of telescoping members 1110a, 1110b, 1110c, 1110d, 1110e, 1110f are not aligned concentrically with one another. In such instances, the center points of the plurality of telescoping members 1110a, 1110b, 1110c, 1110d, 1110e, 1110f are not substantially aligned, or are otherwise not the same.

The proximal end 1102 of the telescoping mechanism 1100, and the proximal ends of the plurality of telescoping members 1110a, 1110b, 1110c, 1110d, 1110e, 1110f are open. Stated another way, the proximal end of the inlet telescoping member 1110a defines an open passage, thereby allowing a flow F of content therethrough.

The telescoping mechanism 1100 is selectively transitioned between the retracted configuration and a plurality of extended configurations. As depicted in FIG. 3A, for example, the telescoping mechanism 1100 is in the retracted configuration. In the retracted configuration, all of the plurality of telescoping members 1110a, 1110b, 1110c, 1110d, 1110e, 1110f are nested, or otherwise housed, within one another. In embodiments, in the retracted configuration, the proximal ends of each of the plurality of telescoping members 1110a, 1110b, 1110c, 1110d, 1110e, 1110f may be aligned. Alternatively or additionally, in instances, the distal ends of each of the plurality of telescoping members 1110a, 1110b, 1110c, 1110d, 1110e, 1110f may be aligned in the retracted configuration. In such instances, a width of each of the plurality of telescoping members 1110a, 1110b, 1110c, 1110d, 1110e, 1110f may be the same as a width of the other plurality of telescoping members 1110a, 1110b, 1110c, 1110d, 1110e, 1110f. As shown in FIG. 3A, in instances, the width of the distal-most telescoping member, such as the end telescoping member 1110f, may be greater than the width of the fifth telescoping member 1110e such that the distal end of the end telescoping member 1110f extends distally beyond the distal end of the fifth telescoping member 1110e in the retracted configuration.

In instances, the telescoping mechanism 1100 is oriented in a partially extended configuration. Stated another way, at least one of the plurality of telescoping members 1110a, 1110b, 1110c, 1110d, 1110e, 1110f remains nested, or otherwise housed, in the interior cavity of a corresponding, proximal telescoping member. For example, as shown in FIG. 3B, the second telescoping member 1110b remains nested, or otherwise housed, within the interior cavity defined by the inlet telescoping member 1110a while the third, fourth, fifth, and end telescoping members 1110c, 1110d, 1110e, 1110f extend from, and are no longer nested within, the interior cavity of the proximally adjacent telescoping member. Alternative partially extended configurations are envisioned where any combination of one or more of the telescoping members 1110a, 1110b, 1110c, 1110d, 1110e, 1110f remain nested, or otherwise housed, within the interior cavity of the proximally adjacent telescoping member.

As shown in FIG. 3C, for example, the telescoping mechanism 1100 is in a fully extended configuration. Stated another way, none of the telescoping members 1110a, 1110b, 1110c, 1110d, 1110e, 1110f are nested, or otherwise housed, within the interior cavity of the proximally adjacent telescoping member.

Although the telescoping mechanism 1100 is shown and described in the context of a design that extends in a single direction between the retracted configuration and the extended configuration, it is contemplated that the telescoping mechanism 1100 could be designed to open in both directions, such as by having an inlet telescoping member 1110a and intermediate telescoping members 1110b-1110e that each have constant inner and outer diameters and using flanges, tabs, or other structural features to travel of each of the telescoping members 1110 relative to one another.

The telescoping mechanism 1100 further includes an extending arm 1200, such as a rod or a bar, for example extending through the telescoping mechanism 1100. The extending arm 1200 is coupled, or otherwise connected, to the telescoping mechanism 1100 by way of an attachment member 1210. In instances, the attachment member 1210 includes a bracket, a clip, a screw, a welded joint, an adhesive, and/or the like. The extending arm 1200 is coupled to a proximal end 1102 of the telescoping mechanism 1100. In instances, the extending arm 1200 is coupled to the proximal-most telescoping member, such as the inlet telescoping member 1110a. In instances, the attachment member 1210 serves as a mechanical stop to prevent the telescoping members 1110b, 1110c, 1110d, 1110e, 1110f from proximally translating out of, or otherwise disengaging from the inlet telescoping member 1110a, for example.

A distal end 1204 of the extending arm 1200 is coupled, or otherwise connected, to the distal end 1104 of the telescoping mechanism 1100. In instances, the distal end 1204 of the extending arm 1200 is fixedly coupled to the distal end 1104 of the telescoping mechanism 1100. The extending arm 1200 can be coupled to the distal end 1104 of the telescoping mechanism 1100 by a bracket, a clip, a screw, a welded joint, an adhesive, and/or the like. The distal end 1204 of the extending arm 1200 is coupled to the wall 1115 of the distal-most telescoping member, such as the end telescoping member 1110f.

The extending arm 1200 is selectively extendable and retractable to facilitate, or otherwise transition, the telescoping mechanism 1100 between the retracted configuration and the extended configurations. As the extending arm 1200 is extended, the extending arm 1200 pushes, or otherwise extends, the distal-most, end telescoping member 1110f in a distal direction. Such a distal pushing force causes the telescoping members 1110b, 1110c, 1110d, 1110e, 1110f to begin sliding, or otherwise moving, out of the interior cavities of the one or more proximal telescoping members. In instances, the extending arm 1200 includes a biasing device, or resilient member, such as a non-magnetic spring, such as a coil spring, for example. In instances, the non-ferromagnetic spring can be comprised of a diamagnetic material, Austenitic Stainless Steel, Beryllium Copper, Cobalt-Nickel alloy, and/or plastic. The resilient member allows a length of the extending arm 1200 to extend and contract in response to a force acting thereon. In instances, extension and/or retraction of the extending arm 1200 can be controlled using the resilient member, an actuator, a hydraulic mechanism, an electric mechanism, and/or the like.

In instances where a hydraulic mechanism is utilized to control the extending arm 1200, the extending arm 1200 is translated based on the fluid pressure within the system. The force exerted by a hydraulic system can be precisely customized by altering the pressure, flow and type of the content flowing in the hydraulic system which can provide a precise and variable force application.

In instances where an electric mechanism is utilized to control the extending arm 1200, a flow sensor such as turbine sensor, thermal flow sensor, ultrasonic flow sensor and/or any suitable flow sensor, can be coupled to the flow redirecting device 1000. In instances, the flow sensor is coupled to the inlet telescoping member 1110a, for example. When a flow reading corresponds to a pre-defined threshold limit, the extending arm 1200 may extend to transition the telescoping mechanism 1100 into an extended position.

The extending arm 1200 can be extended in response to a flow F of content, such as a fluid, entering the flow redirecting device 1000 through the proximal end 1102 of the telescoping mechanism 1100. The flow F of content passes through the open proximal and distal ends of the telescoping members 1110a, 1110b, 1110c, 1110d, 1110e until the content reaches the end wall 1115 of the distal-most, end telescoping member 1110f. The flowing content pushes against, or otherwise abuts, the end wall 1115 with a force sufficient to extend, or otherwise pull, the extending arm 1200. In instances, the pulling force acting on the extending arm 1200 can cause the actuator to extend a length of the extending arm 1200. A degree to which the telescoping mechanism 1100 is extended is based, at least in part, on a characteristic of the flowing content, such as a flow rate, for example.

As the extending arm 1200 is retracted, the extending arm 1200 pulls, or otherwise retracts, the distal-most, end telescoping member 1110f proximally, thereby causing the telescoping members 1110a, 1110b, 1110c, 1110d, 1110e, 1110f to slidably nest within one another. Stated another way, a length of the extending arm 1200 is reduced as the telescoping mechanism 1100 transitions toward the retracted configuration.

The length of the extending arm 1200 can be reduced, or otherwise retracted, in response to an absence and/or a decrease in the flow F of content, such as a fluid, passing through the flow redirecting device 1000. Stated another way, in instances where a pushing force, such as from content flow, no longer acts on the wall 1115 of the distal-most, end telescoping member 1110f to a degree sufficient to overcome a resilience of the resilient member, for example, the actuator pulls the extending arm 1200 proximally as the actuator returns to a rest state. Such instances can occur when the content is no longer flowing through the flow redirecting device 1000 or when the content is flowing through the flow redirecting device 1000 at a slower rate, for example. This occurs when the flow redirecting device 1000 is released from the wall of the vessel and is allowed to be freely carried by the flow of material passing through the vessel.

In instances, the telescoping mechanism 1100 can manually be transitioned between the retracted configuration and the extended configurations. For example, the telescoping mechanism 1100 can be manually transitioned into the extended configuration prior to insertion into the vessel. Similarly, the telescoping mechanism 1100 can be manually transitioned into the retracted configuration upon retrieval out of the vessel for storage purposes, for example. The telescoping mechanism 1100 can include a locking mechanism to selectively retain the telescoping mechanism 1100 in the retracted configuration and/or the extended configuration. For example, the locking mechanism can be engaged to maintain the telescoping mechanism 1100 in the retracted configuration for efficient storage of the flow redirecting device 1000. The locking mechanism can then be disengaged prior to insertion into a particular vessel, so as to allow the telescoping mechanism 1100 to freely transition into the one or more extended configurations. In instances, the locking mechanism can include a hinge, a latch, and/or the like. In instances, the extending arm 1200 can be prevented from extending to transition the telescoping mechanism 1100 into an extended configuration when the flow redirecting device 1000 is not coupled to the wall of the vessel. In instances, the extending arm 1200 can be prevented from extending to transition the telescoping mechanism 1100 into an extended configuration when the flow redirecting device 1000 is not in a desirable orientation and/or position within the vessel.

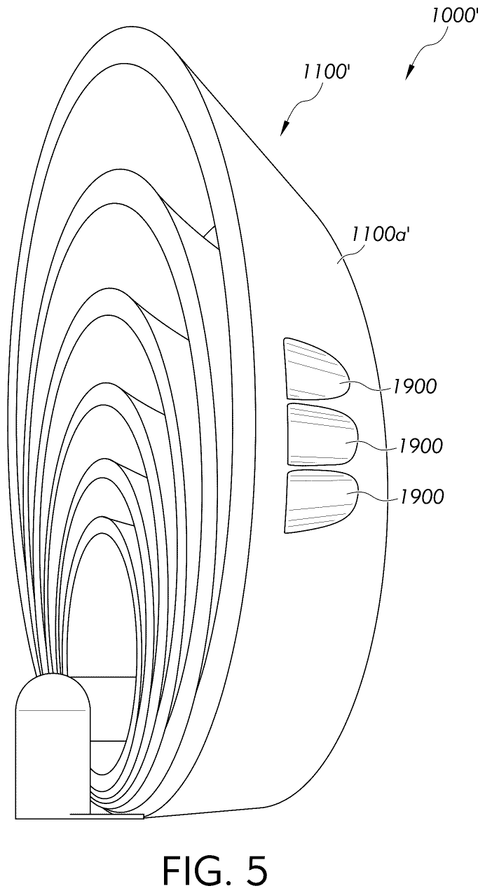

Referring now to FIG. 5, in instances, the inlet telescoping member 1110a of the telescoping mechanism 1100 can include one or more cavities 1900 defined in a sidewall, or outer surface, thereof. The one or more cavities 1900 can be through holes to permit content to flow therethrough. The flow of content through the one or more cavities 1900 generates a drag force resulting in a torque, or rotational force, rotating the flow redirecting device 1000 within the vessel. In instances, the one or more cavities 1900 can function to correct an orientation of the flow redirecting device 1000 to align the flow redirecting device 1000 with a flow axis to allow the content to flow into the telescopic mechanism 1100. In embodiments, the telescoping mechanism 1100 can be configured to open in both directions and, therefore, may not have the cavities 1900 for orienting the flow directing device 1000 in the correct alignment relative to the flow in the vessel.

In instances, a filter, or a mesh, can be coupled to the proximal end 1102 of the telescoping mechanism 1100. The filter can include openings sized to prevent any unwanted materials and/or impurities from passing through the flow redirecting device 1100, as such unwanted materials and/or impurities that can clog, or otherwise block a flow passage within the flow redirecting device 1100, for example. In any event, the filter can prevent any material larger than the diameter of the aperture 1150 from entering, or otherwise attempting to pass through, the flow redirecting device 1000. The filter can be made from any suitable material that can withstand the conditions within the vessel, such as temperature, pressure, flow, and/or the like. A particular filter can be selectively coupled to the telescoping mechanism 1100 based on a particular use, as different processes involve different impurities, for example. In instances, the filter is fixedly coupled to the telescoping mechanism 1100. In other instances, the filter is removably coupled to the telescoping mechanism 1100 and can be selectively coupled thereto and/or removed therefrom during a particular use.

Referring again to FIG. 1, the flow directing device 1000 includes a ferromagnetic metal plate 1800 that facilitates attachment of the flow directing device 1000 to the wall of the vessel in response to application of a magnetic field. The ferromagnetic metal plate 1800 can be coupled, or otherwise attached to, the inlet telescoping member 1110a in any suitable manner. The ferromagnetic metal plate 1800 can be positioned on, embedded within, and/or made integral with the inlet telescoping member 1110a, for example. In instances, the ferromagnetic metal plate 1800 is coupled to a sidewall within the interior cavity defined by the inlet telescoping member 1110a. As described in greater detail herein, the ferromagnetic metal plate 1800 can be used to orient, or otherwise position, the flow redirecting device 1000 within the vessel. The ferromagnetic metal plate 1800 is located on the same side of the telescoping member as the aperture 1150.

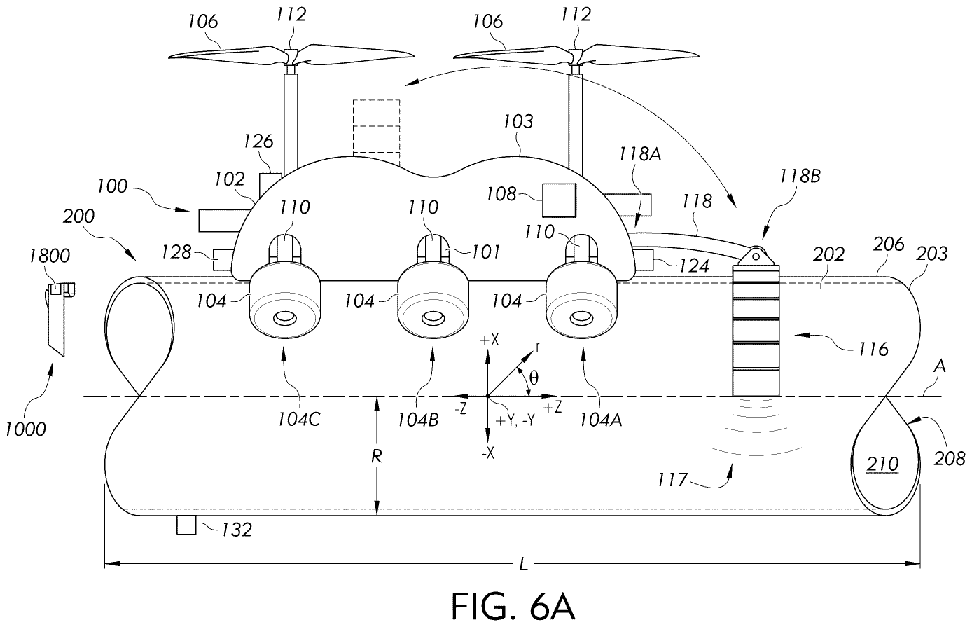

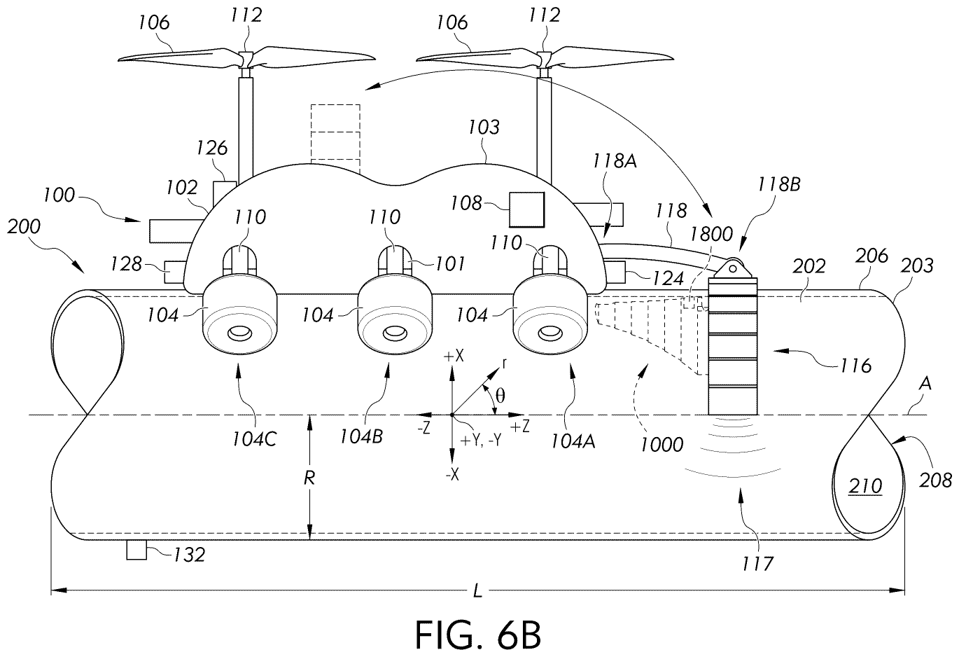

More specifically, with reference to FIGS. 6A and 6B, a magnet controlling mechanism, a magnet positioner, and/or a robot, 100 is depicted for servicing a vessel 200. Such magnet controlling mechanisms are described in greater detail in commonly-owned and co-pending U.S. patent application Ser. No. 18/601,631, entitled ROBOTS FOR SERVICING METAL EQUIPMENT, filed on Nov. 3, 2023, the entirety of which is hereby incorporated by reference. The vessel 200 is comprised of a metal material. The robot 100 includes a body 102 and a plurality of magnetic wheels 104 operatively attached to the body 102. The plurality of magnetic wheels 104 are operable to attach the robot 100 to a metal surface 202 of the vessel 200. In instances, the robot 100 includes a plurality of propellers 106 coupled to the body 100.

The body 102 of the robot 100 includes a chassis 101 and an outer cover 103 coupled to the chassis 101, and the plurality of magnetic wheels 104 are operatively coupled to the chassis 101. The plurality of magnetic wheels 104 are operable to attach the robot 100 to a metal surface 202 of the vessel 200. The vessel 200 may include at least one side wall 206 with an interior surface 208 defining an internal volume 210 of the vessel 200 and the metal surface 202 may be an external surface of the at least one side wall 206. The vessel 200 may have the center axis A, the axial length L measured parallel to the center axis A, and the outer perimeter OP, where the outer perimeter OP is a shape of the metal surface 202 of the at least one side wall 206 of the vessel 200 in the plane perpendicular to the center axis A.

The robots, systems, and methods may include moving the robot 100 to various positions on the metal surface 202 to scan the interior surface 208 and attract a metallic object, such as the ferromagnetic metal plate 1800 of the flow redirecting device 1000, for example, to various points on the interior surface 208 to loosen solid deposits 201 on the interior surface 208, as discussed further herein. More specifically, FIGS. 6A and 6B depict the flow redirecting device 1000 in two different positions within the vessel 200. FIG. 6B depicts the flow redirecting device 1000 after the robot 100 attracted the ferromagnetic metal plate 1800 of the flow redirecting device 1000 to a desired position. Robots, systems, and methods of the present disclosure may include moving the robots 100 on the metal surface 202 through the magnetic wheels 104. Additionally or alternatively, the robots 100, systems, and methods of the present disclosure may include moving the robots 100 using the propellers 106 or through the use of a drone. Using the robots 100 to service the vessel 200 may reduce or eliminate the need for human involvement when cleaning and/or inspecting the interior surface 208 of the vessel 200. Additionally or alternatively, the robots 100 and methods of using the robots 100 to service the vessel 200 may enable servicing equipment that would otherwise be inaccessible without construction of additional access means or deconstruction of the vessel 200. Moreover, the systems and methods of the present disclosure may eliminate the need to shut down the system to remove solid deposits 201 from the interior surface 208. This may result in increased efficiency by removing the solid deposits 201 while the system is running and maintaining the equipment at operating temperature and pressure, which eliminates the need for heating up and cooling down equipment for removing the solid deposits through conventional mechanical tools. The systems and methods of the present disclosure may also allow for offline removal of solid deposits.

Referring to FIGS. 6A and 6B, the robot 100 includes a plurality of sets of magnetic wheels 104, such as a first set 104A, a second set 104B, and a third set 104C of the plurality of magnetic wheels 104 attached to the metal surface 202. Although shown with three sets of magnetic wheels 104 in FIGS. 6A and 6B, it should be understood that the robot 100 may have any number of sets of the plurality of magnetic wheels 104 attached to the body 102 of the robot 100, such as 1, 2, 3, 4, 5, 6, or more than 6 sets of magnetic wheels 104. Also of note is that only one side of the robot 100 is visible in FIG. 6A and FIG. 6B.

The plurality of magnetic wheels 104 may be of any shape to attach the robot 100 to the metal surface 202. In embodiments, the magnetic wheels 104 do not rotate and simply attach the robot 100 to the metal surface 202. In embodiments, the magnetic wheels 104 may be rotatable relative to the body 102 of the robot 100. The magnetic wheels 104 may be freely rotatable relative to the robot 100, such that activation of the propellers 106 may traverse the robot 100 along the metal surface 202. In instances, the magnetic wheels 104 can be coupled to a wheel drive 110 operable to rotate each of the plurality of magnetic wheels 104 relative to the chassis 101. When driven, the magnetic wheels 104 can be operated to move the robot 100 along the metal surface 202 of the vessel 200 alone or in combination with the propellers 106.

In instances, the magnetic wheels 104 may each include permanent magnets. The permanent magnets may be used if low temperature chemical processing (such as less than 100° C.) are taking place within the metal equipment 200. The magnetic wheels 104 may also comprise electromagnets. An electric current may be provided to the electromagnets to activate the electromagnets. Electric current provided to the electromagnets activates the electromagnets and induces an electromagnetic field in the magnetic wheels 104. The electromagnetic field may produce an electromagnetic force that is sufficient to cause the robot 100 to attach to the metal surface 202. When the electric current is no longer supplied to the magnetic wheels 104, the magnetic wheels 104 may be deactivated and, thus, the robot 100 may no longer be magnetically attached to the metal surface 202.

In instances, the magnetic wheels 104 may be electromagnets and may have an adjustable electromagnetic force that the magnetic wheels 104 produce. In instances, the intensity of the electromagnetic force the magnetic wheels 104 produces may be based on the amount of electric current running through the electromagnets. The intensity of the electromagnetic force required in the electromagnets may depend on a weight of the robot 100, whether the vessel 200 is located outdoors, and/or a number of the magnetic wheels 104. For example, a vessel 200 outdoors may experience wind, rain or other inclement weather. As such, a stronger electromagnetic force in the electromagnets may be required if a heavy robot 100 with 4 wheels is to be attached to vessel 200 that is outdoors when compared to the electromagnetic force required if a lighter robot 100 with 10 wheels is to be attached to vessel 200 that is indoors. In instances, the propellers 106 may be adjusted and operated to provide additional force to maintain the robot 100 in contact with the metal surface 202 of the vessel 200.

Referring again to FIG. 6A, in instances in which the magnetic wheels 104 include electromagnets, the robot 100 may further include an electrical power source 108 electrically coupled to each of the magnetic wheels 104. The electrical power source 108 may provide the current to the magnetic wheels 104 to activate the electromagnets. The electrical power source 108 may include a rechargeable battery, disposable batteries, or any other suitable power source. The electrical power source 108 may be charged through the use of a recharging station. The electrical power source 108 may also power other components of the robot 100 such as the propellers 106, the wheel drive 110, or combinations of these.

In instances, the robot 100 may further include the wheel drive 110 operatively coupled to the body 102 of the robot 100. The wheel drive 110 may extend substantially perpendicular to a side, front, and/or back of the robot 100. The wheel drive 110 may be operable to rotate each of the magnetic wheels 104 relative to the body 102 to move the robot 100 relative to the metal surface 202 of the vessel 200. The wheel drive 110 may cause the robot 100 to move in a forward or backward direction. The robot 100 may comprise one, two, three, four, or more than 4 wheel drives 110. The wheel drive 110 may attach to all of the magnetic wheels 104 or only some of the magnetic wheels 104. The wheel drive 110 may be operable to rotate the magnetic wheels 104 at varying speeds and, thus, cause the robot 100 to traverse the metal surface 202 at various speeds. The magnetic wheels 104 may cause the robot 100 to travel in a straight line, or the magnetic wheels 104 may turn the robot 100 in different directions, such as by rotating certain magnetic wheels 104 and leaving others stationary, or by rotating different magnetic wheels 104 at different rotational speeds.

In instances, the magnetic wheels 104 may be operable to pivot relative to the body 102 to move the robot 100 vertically, horizontally, or both with respect to the metal surface 202. The first set 104A of magnetic wheels 104 may be operable to pivot, while the second set 104B and the third set 104C of the magnetic wheels 104 may not pivot. As such, pivoting of the first set 104A of magnetic wheels 104 may turn the robot 100 to move in a particular direction. In instances, the second set 104B and the third set 104C may also be operable to pivot, such that the robot 100 may travel in a diagonal direction when all sets of magnetic wheels 104 are pivoted in a direction. Power from the wheel drive 110 may be strong enough to move the robot 100. However, in embodiments, the propellers 106 may operate in conjunction with the magnetic wheels 104 assist in moving the robot 100.

The plurality of propellers 106 may be operable to reposition the robot 100 on the metal surface 202 of the vessel 200. The propellers 106 may provide propulsion to the robot 100 to assist the wheel drive 110 in traversing the robot 100 along the metal surface 202. The propellers 106 may provide enough propulsion to the robot 100 to traverse the robot along the metal surface 202, such that the wheel drive 110 is unnecessary. In such embodiments, the propellers 106 may rotate to provide propulsion to the robot 100 and the magnetic wheels 104 may pivot to change direction of the robot 100, as explained above. The propellers 106 may be electrically coupled to the electrical power source 108.

In embodiments, the robot 100 may weigh 1 kg, 2 kg, 4 kg, 10 kg, 25, kg, 50 kg, or more depending on dimensions of the robot 100 and/or attachments on the robot 100. The robot 100 may transfer a force onto the vessel 200 when the robot 100 is attached to the vessel 200, such that the force transferred to the vessel 200 may equal the weight of the robot 100. In embodiments, the force the robot 100 transfers to the vessel 200 may be greater than a force limit of the vessel 200. For example, the vessel 200 may be capable of withstanding forces of up to 10 kg without deforming. If the weight of the robot 100 is over 10 kg, the weight of the robot 100 would result in damage to the vessel 200 when the robot is attached to the metal surface 202 of the vessel 200.

As such, the plurality of propellers 106 may also be operable to generate a lifting force to counteract a weight of the robot 100. The plurality of propellers 106 may be operable to generate a lifting force to counteract 10%, 20%, 40%, 60%, 80% or 100% of the weight of the robot 100. As such, the lifting force of the propellers 106 will allow the robot 100 that weighs more than the force limit of the vessel 200 to still be attached to the vessel 200.

The robot 100 may also change direction due to the propellers 106 changing orientation. As such, each of the propellers 106 may be attached to and rotatable relative to the body 102 of the robot 100. In embodiments, one or each of the propellers 106 may include a propeller positioner 112 operable to change an orientation of the propellers 106. The propeller positioner 112 may be operable to rotate one or all of the propellers 106 through 360 degrees relative to the body 102 of the robot 100, such that the propellers 106 may provide propulsion to the robot 100 in any direction. As noted hereinabove, the propellers 106 may be operated to apply a force that causes the magnetic wheels 104 to rotate, traversing the robot 100 along the metal surface 202. The propellers 106 may also lift the robot 100 off of the metal surface 202.

The propellers 106 may lift the robot 100 off of the metal surface 202 and then move the robot 100 to another position on the metal surface 202. The robot 100 may become reattached to the metal surface 202 when the propellers 106 bring the robot 100 close enough to the metal surface 202 such that the magnetic wheels 104 attract the robot 100 to the metal surface 202. When the magnetic wheels 104 are electromagnets, the robot 100 may not be reattached to the metal surface 202 until the electromagnets have been turned back on.

In instances, the robot 100 may also include a drone with a drone body. The drone may be operable to move the robot 100 to different locations along the metal surface 202. The drone may include the propellers 106 coupled to the drone body, such as drone propellers, such that the drone propellers may provide propulsion to the drone, allowing the drone to fly. As with the propellers 106 attached to the body 102 of the robot 100, the drone propellers attached to the drone body of the drone may include propeller positioners operable to change the orientation of the propellers 106 360 degrees relative to the drone body.

The drone body may include drone extensions. The drone extensions may be operable to perch the drone onto the metal surface. The drone extensions may rest on the metal surface such that the drone propellers of the drone may turn off and the drone may be perched on the metal surface. In embodiments, the drone extensions may include drone extension magnets to attach the drone extensions to the metal surface. The drone extension magnets may include permanent magnets or electromagnets.

The drone body of the drone may be releasable from the body 102 of the robot 100. The drone body may be releasably coupled to the drone body through drone attachments extending from the drone body. The drone attachments may be disposed on an underside of the drone body, such that the drone may be perched over the robot 100 and connect to the robot 100 through the drone attachments. The drone attachments may include drone attachment magnets that attach to the body 102 of the robot 100. The attachment magnets may include permanent magnets or electromagnets. The drone attachments may attach the drone to the body 102 of the robot 100 in a variety of manners, such as but not limited to hook connections, clips, suction cup connections, threaded connections, or any other suitable connection type.

In embodiments, the drone extensions and the drone attachments may be retractable from the drone body. The drone extensions and the drone attachments may be retracted into the drone body when not in use, such as when the drone is flying to another location of the metal surface 202 when it is not carrying the robot 100. When the drone 400 reaches a location on the metal surface 202 where the robot 100 is located, the drone extensions 404 and/or the drone attachments may extend from the drone body 402 to perch the drone on the metal surface 202 and attach to the body 102 of the robot 100.

The drone may include a drone power source electrically coupled to the drone propellers, the drone extensions, the drone extension magnets, the drone attachments, and/or the drone attachment magnets. The drone power source may include a rechargeable battery, disposable batteries, or any other suitable power source.

Referring again to FIG. 6A, the robot 100 may further include a magnet 116 coupled to the body 102. The magnet 116 may be operable to attract the metallic object, such as the ferromagnetic metal plate 1800, to a first position 251 on the metal surface 202. The magnet 116 may extend around at least a portion of the metal surface 202.

The magnet 116 may guide movement of the metallic object, such as the ferromagnetic metal plate 1800, within the vessel 200. The magnet 116 may be an electromagnet, permanent magnet, or any other suitable magnet type. A permanent magnet may be used as the magnet 116 if low temperature chemical processing (such as less than 100° C.) are taking place within the vessel 200. If the magnet 116 is an electromagnet, an electric current may be provided to the electromagnet. Electric current provided to the electromagnet activates the electromagnet and induces a magnetic field 117 around the magnet. When the electric current is no longer supplied to the magnet 116, the magnet 116 may be deactivated. The electric current supplied to the magnet 116 may be separate from the electric current supplied to the magnetic wheels 104, such that the magnetic wheels 104 may be activated while the magnet 116 is deactivated, or the magnetic wheels 104 are deactivated while the magnet 116 is activated.

The magnet 116 may be connected to the body 102 in a variety of manners. In embodiments, the magnet 116 may be connected to the body 102 through a retractable arm 118. The retractable arm 118 may have a proximal end 118A and a distal end 118B. The proximal end 118A may be coupled to the body 102, such as being attached to the body 102 at a pivot point so that the arm 118 can be rotated about the pivot point relative to the body 102. The distal end 118B may be coupled to the magnet 116, such as being rigidly attached to the magnet 116. The retractable arm 118 may be straight, curved, or any other suitable shape with respect to a shape of the retractable arm 118 between the proximal end 118A and the distal end 118B.

FIG. 6A depicts the retractable arm 118 in an engaged position. In the engaged position, the magnet 116 is engaged with the metal surface 202. In contrast, in a retracted position of the retractable arm 118, the magnet 116 is disengaged with the metal surface 202. When in the retracted position, the retractable arm 118 may cause the magnet 116 to raise from the metal surface 202 by any distance. In embodiments, when the retractable arm 118 is in the retracted position, the retractable arm 118 may be partially or entirely disposed within a cavity 122 within the body 102. The cavity 122 allows the retractable arm 118 to be stored within the body 102, such as when the drone is attaching to the robot 100 to move the robot 100, for example. The cavity 122 may also be large enough to partially or entirely store the magnet 116.

In embodiments, the robot 100 may include a single magnet 116 attached to the distal end 118B of the retractable arm 118. In embodiments, the robot may 100 include a plurality of magnets 116 attached to the distal end 118B of the retractable arm 118, as depicted in FIG. 6A. Each of the magnets 116 may be independently activated, such as to attract the metallic object, such as the ferromagnetic metal plate 1800, to a point on the interior surface 208 of the vessel 200 corresponding to a position of the magnet 116 on the metal surface 202.

In instances, a system for servicing metal equipment may include a plurality of robots 100 to which a plurality of magnets 116 are coupled. The plurality of robots 100 may be positioned at various locations on the metal surface 202 of the vessel 200. The robots 100 may utilize the magnets 116 to attract the metallic object, such as the ferromagnetic metal plate 1800, to the interior surface 208 of the vessel 200 to reduce the solid deposit 201 buildup on the interior surface 208. The robots 100 may do so through activation and deactivation of the magnets 116.

Using the described magnet controlling mechanisms 100 and/or robots, the flow redirecting device 1000 can selectively be oriented and/or positioned within the vessel 200. In instances, the magnet controlling mechanisms 100 can be used to couple the flow redirecting device 1000 to a wall of the vessel 200, for example. The magnet controlling mechanisms 100 can further be used to guide the flow redirecting device 1000 through the vessel 200 before, during, and after the flow redirecting device 1000 is being used.

Referring again to FIG. 6A, the robot 100 may further include a camera 124 coupled to the body 102. The camera 124 may capture image data of the metal surface 202. The image data may detect the metal surface 202. In embodiments, the image data may be used to determine a relative distance or position of the robot 100, drone, or both relative to the metal surface 202 of the vessel 200. Image data from the camera 124 may act as a guide for the robot 100 or the drone. The image data may also detect a curvature of the metal surface 202, such that the magnetic wheels 104 of the robot 100 may be properly placed onto the metal surface 202 of the vessel 200.

The robot 100 may also include a location sensor 126. The location sensor 126 may be operable to produce a signal indicative of a location of the robot 100. The location of the robot 100 may correspond to a position on the metal surface 202; the location of the robot 100 may also correspond to a location off of the metal surface 202, such as when the robot 100 has been removed from the metal surface 202 through the propellers 106 or by the drone. The location sensor 126 may be a global positioning system (GPS), a geomagnetic field sensor, hall-effect position sensors, or any other suitable location sensor. In embodiments, the location sensor 126 may be a radar or LIDAR sensor capable of determining the position of the robot 100, drone, or both relative to other objects, such as the vessel 200, other robots 100 or drones, or other stationary or mobile equipment. The location sensors 126 may be operated to guide the robot 100, drone 400 or both when moving the robot 100, drone 400, or both relative to the vessel 200.

In embodiments, the robot 100 may also include one or more inspection sensors 128. The inspection sensors 128 may detect surface characteristics of the interior surface 208 of the side wall 206, while not being inserted into the internal volume 210 of the vessel 200. The inspection sensors 128 may also detect irregularities in the surface characteristics of the interior surface 208, such as the solid deposits 201 on the interior surface 208. The inspection sensors 128 may be coupled to the body 102 or to the distal end 118B of the retractable arm 118.

In embodiments, the inspection sensor 128 may be a gamma scanner. In embodiments, the inspection sensor 128 may include a ray emitter 131 which may emit electromagnetic waves (such as, but not limited to, gamma-rays) into the vessel 200. On an opposing side of the metal surface 202, the inspection sensor 128 may also include a ray sensor 132, which may detect the rays emitted from the ray emitter 131. The ray sensor 132 may be coupled to the robot 100 or the ray sensor 132 may be carried by another one of the robots 100 opposite the robot 100 carrying the ray emitter 131.

Based on the detected rays, the inspection sensor 128 may detect the irregularities in the surface characteristics of the interior surface 208. In embodiments, the inspection sensor 128 may be a gamma-ray sensor or an X-ray sensor, or any other suitable sensor for detecting interior surface characteristics of the vessel 200. In embodiments, the robot 100 may comprise a single inspection sensor 128 or a plurality of inspection sensors 128. The inspection sensors 128 may include mechanical/physical sensors, electromagnetic sensors, thermal sensors, acoustic/ultrasonic sensors, and/or radiation sensors.

While various systems and methods have been described for orienting, or otherwise moving, a flow redirecting device within a vessel, the flow redirecting device and the components thereof may be introduced to the vessel by way of an injection system, for example. Exemplary injection systems are described in greater detail in commonly-owned and co-pending U.S. patent application Ser. No. 18/344,498, entitled SYSTEMS AND PROCESSES FOR CHEMICAL PROCESSING, filed on Jun. 29, 2023, the entirety of which is hereby incorporated by reference. Such injection systems can be for injecting elements into an internal volume of a vessel through at least one inlet.

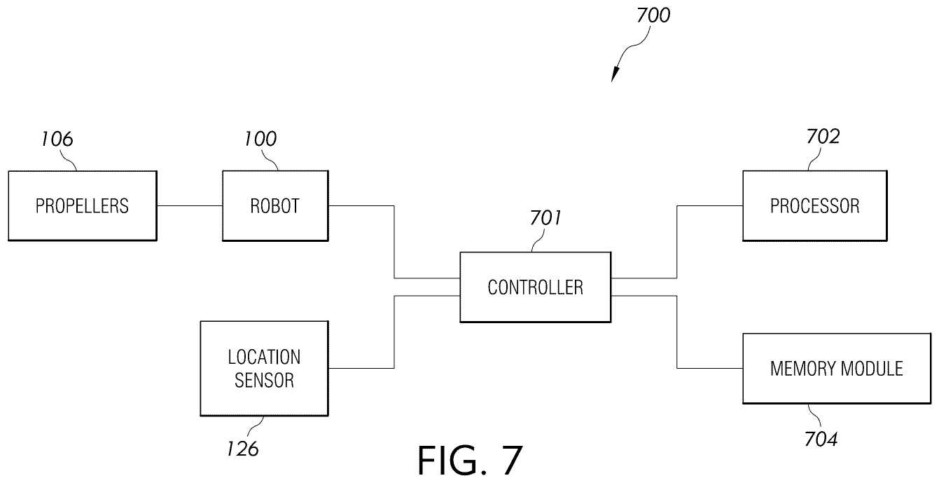

Referring now to FIG. 7, a system 700 for traversing the metal surface 202 for use with the robots 100 as discussed above is depicted. The system 700 may include a control system 701 communicatively coupled to the robot 100, drone, or both and thus, to a plurality of components connected to the robot 100, the drone, or both, as described further below, including the location sensor 126. The control system 701 may include one or a plurality of processors 702, at least one memory module 704 communicatively coupled to the processor 702, and computer readable and executable instructions stored on the at least one memory module 704. The processor 702 can be any device capable of executing machine readable instructions. The machine readable and executable instructions 706, when executed by the processor 702, may cause the system 700 to automatically perform one or more functions described herein.

The propellers 106 of the robot 100 may be communicatively coupled to the control system 701. The machine readable and executable instructions 706, when executed by the processor 702, may cause the system 700 to automatically activate the propellers 106 for at least one of the plurality of robots 100. In embodiments, the system 700 may activate one, two, three, four, or all of the propellers 106 of the robots 100.

The system 700 may map locations of the robots 100 relative to the metal surface 202 with the location sensors 126. Moreover, the system 700 may map the locations of the robots 100 relative to one another. Thus, once the propellers 106 have been activated, the machine readable and executable instructions 706, when executed by the processor 702, may further cause the system 700 to automatically position the robots 100 on the metal surface 202. The system 700 may detach and attach the robots 100 to a variety of different points on the metal surface 202.

The machine readable and executable instructions 706, when executed by the processor 702, may cause the system 700 to automatically detach the robots 100 from a first set of points, fly the robots 100 to a second set of points using the propellers 106, and attach the robots 100 to the second set of points on the metal surface 202. The robots 100 may subsequently detach and attach to various points on the metal surface 202. In embodiments, the robots 100 may attach to all points on the metal surface 202. The robots 100 may attach to the metal surface 202 through the magnetic wheels 104.

The magnet controlling mechanisms described herein can be utilized to move the one or more flow redirecting devices 1000 to various locations within the vessel. For example, the vessel can include a first solid deposit in a first location and a second solid deposit in a second location. After the flow redirecting device 1000 has sufficiently eroded the first solid deposit in the first location, the magnet controlling mechanisms can cause the flow redirecting device 1000 to move to the second location to address the second solid deposit, for example. Such steps can be repeated until an entire vessel has been cleaned.

In instances where the flow redirecting device 1000 includes the ferromagnetic metal plate 1800 and one or more cavities 1900 defined in a telescoping member 1100a′, the one or more cavities 1900 are positioned approximately 90 degrees radially away from the ferromagnetic metal plate 1800 where the drag force exerted on the cavities 1900 allows for maximum rotational force to be generated. However, it is envisioned that the cavities 1900 can be located at any angle radially with respect to the ferromagnetic metal plate 1800 that generates sufficient rotational force to rotate the telescoping mechanism in the retracted configuration but not sufficient to rotate the telescoping mechanism in an extended configuration, such as a fully extended configuration, for example.

More specifically, a magnetic force \vec{F}ₘ is keeping the flow redirecting device in a state of equilibrium. The magnetic force \vec{F}ₘ is a force that has been generated due to the interaction between the magnetic field B of the magnet with the induced magnetic field in the ferromagnetic metal plate 1800. The magnetic force \vec{F}ₘ provides a centripetal component that allows the flow redirecting device to rotate about an axis perpendicular to the direction of the magnetic field \vec{B} while it is still attached to the magnet. The axis which the devices rotate about is tangential to the direction of the applied force \vec{F}ₐ and passes through center of mass of the flow redirecting device. When, \vec{F}ₐ is applied tangentially on the flow redirecting device, a torque (rotational force) will be generated about the center of mass of the device. The torque \vec{τ} is given by:

$$\vec{τ} = \vec{r} {\vec{F}}_{a} sin θ \qquad ( 1 )$$

Where \vec{τ} is the torque, \vec{r}′ is the position vector from the axis of rotation to the line where the force is applied. However, when the force is applied tangentially sin θ=1 which gives a simplified torque equation:

$$\vec{τ} = \vec{r} {\vec{F}}_{a} \qquad ( 2 )$$

A factor that determines the rotational ability of the device is the net torque Σ\vec{τ} where according to the rotational form of Newton's second law, the device can only rotate when the Σ\vec{τ} is not zero which means the applied torque must be higher than the static frictional torque in order for the device to rotate.

$$\sum \vec{τ} = I \vec{α} \qquad ( 3 )$$

Where I is the moment of inertia of the device which is a measurement of device's resistance to rotation, determined based on the shape and mass distribution of the device, for example, and \vec{α} is the angular acceleration which according to the rotational form of Newton's second law is the rate of change in angular velocity.

In instances, more than one flow redirecting device 1000 can be utilized within a vessel in a particular situation. Any suitable number of flow redirecting devices 1000 can be deployed within the vessel such that a content flow or pressure is not adversely affected to an extent that affects a process outcome.

In instances, one or more artificial eroding objects 1700 can be suspended, or otherwise present, in the content flowing through the flow redirecting device 1000. The one or more artificial eroding objects 1700 service to artificially erode deposits 1750 accumulated within a vessel, such as along a vessel wall, for example. In instances, the one or more artificial eroding objects 1700 include small objects which can collide naturally with deposits 1750 to erode the deposits 1750 slowly without affecting a coating on the inner walls of the vessel, for example. The one or more artificial eroding objects 1700 can be manufactured from any non-ferromagnetic material that suits particular parameters and type(s) of content inside the vessel to make the artificial erosion behave more naturally while not being affected by a magnetic field. In instances, the one or more artificial eroding objects 1700 can include a material that prevents deposits from forming and/or reforming. In instances, particles already present within the vessel, such as sand, for example, can be used in combination with the artificial eroding objects 1700 to enhance the artificial erosion of deposits 1750, for example. The artificial eroding objects 1700 may be any non-ferromagnetic material, such as but not limited to non-ferromagnetic metals, ceramics, glass particles, sand, dirt, silica, zeolites, other types of non-ferromagnetic particles, or combinations of these particles.

In instances, the one or more artificial eroding objects 1700 remain in the vessel after being used for eroding deposits 1750. A filter, such as a mesh, can be placed within the vessel to collect the one or more artificial eroding objects 1700. As such, the one or more artificial eroding objects 1700 can be removed from the remaining content flowing through the vessel and/or can be reused. The one or more artificial eroding objects 1700 can be used to artificially erode the deposits 1750 with or without the use of the flow redirecting device 1000. Stated another way, the artificial eroding objects 1700 can be introduced into the vessel regardless of whether the flow redirecting device 1000 is present; however, the flow redirecting device 1000 can be utilized to achieve a more targeted dispersion of the artificial eroding objects 1700, for example.

In instances, the one or more artificial eroding objects 1700 can include substantially similar sizes and/or geometries. In other instances, the one or more artificial eroding objects 1700 can include a variety of sizes and/or geometries. As an overall size of the artificial eroding objects 1700 increases, damage to, or otherwise erosion of, the deposit 1750 increases. Particular size(s) of the artificial eroding objects 1700 can be introduced into the vessel based on characteristics of a particular situation, such as deposit type, deposit size, vessel size, and/or the like. For example, in instances where the deposit 1750 is relatively thick, a larger artificial eroding object 1700 can be used to initially erode the deposit 1750. After an initial erosion period, smaller artificial eroding objects 1700 can be introduced into the vessel so as to minimize contact and/or damage to the wall, or protective coating present on the wall, of the vessel, for example.

In instances where the artificial eroding objects 1700 are being used with a flow redirecting device, the diameter of the one or more artificial eroding objects 1700 does not exceed 10% of the diameter of the aperture 1150, for example. However, instances are envisioned where the diameter of the one or more artificial eroding objects 1700 exceeds 10% of the diameter of the aperture 1150.

The shape, or overall geometry, of the one or more artificial eroding objects 1700 can affect an erosion rate as an angular object can erode a deposit 1750 at a faster rate than a smooth, or rounded, object, for example. Particular shape(s) of the artificial eroding objects 1700 can be introduced into the vessel based on characteristics of a particular situation, such as a deposit type, deposit size, vessel size, and/or the like. For example, in instances where the deposit 1750 is relatively thick, a more angular, or sharp, artificial eroding object 1700 can be used to initially erode the deposit 1750. After an initial erosion period, a smoother, round artificial eroding object 1700 can be introduced into the vessel so as to minimize damage to the wall, or protective coating present on the wall, of the vessel, for example.

In instances, a concentration of the one or more artificial eroding objects 1700 within the vessel can be selected based on characteristics of a particular situation. For example, an increased concentration of the one or more artificial eroding objects 1700 within the vessel corresponds to an increase in an erosion rate of the deposit 1750 as more eroding objects 1700 present within the vessel results in more collisions, or interactions, between the eroding objects 1700 and the deposit 1750.

Various material properties of the one or more artificial eroding objects 1700 can affect an erosion rate. For example, artificial eroding objects 1700 having an increased surface roughness can cause more erosion of deposits 1750 than artificial eroding objects 1700 having a reduced surface roughness, for example. In embodiments, a surface roughness of an artificial eroding object 1700 having a fine and/or smooth texture can range between 0.1 μm to 1 μm. A surface roughness of an artificial eroding object 1700 having a medium roughness can range between 1 μm and 10 μm, for example. A surface roughness of an artificial eroding object 1700 having a high surface roughness can be above 10 μm, for example. Artificial eroding objects 1700 comprised of different materials can be used based on characteristics of a particular situation. For example, in instances where the deposit 1750 is relatively thick, artificial eroding objects 1700 manufactured from a material having an increased surface roughness can be introduced into the vessel. As the deposit 1750 gets thinner, or in instances where a thickness of the deposit 1750 is relatively thin, artificial eroding objects 1700 manufactured from a material having a decreased surface roughness can be introduced into the vessel.

The nonmetallic material(s) used to manufacture the one or more artificial eroding objects 1700 must possess a sufficient hardness to endure operational conditions of the system. For example, a preferable hardness is within a range suitable for the particular nonmetallic material, measured on the Durometer scale as per ASTM D2240 for plastic and rubber. However, for other nonmetallic materials, such as ceramics, a different testing method should be used, such as ASTM C1327 to test Vickers hardness (HV), for example. In embodiments, the artificial eroding objects 1700 may have a Vickers hardness of from 500 HV to 3,000 HV. Such testing ensures that the material can withstand various stresses such as compression, stretching, and/or impact without deformation and/or damage. For example, if the hardness of a particular material is below a recommended range per the ASTM standards, the artificial eroding objects 1700 can be more susceptible to mechanical wear, deformation, and/or damage during processes involving environmental stressors. Such environmental stressors include, for example, aggressive substances and/or conditions.

As discussed herein, the one or more artificial eroding objects 1700 are utilized in an effort to remove deposits 1750 and/or prevent additional deposits from forming within the vessel. Deposition prediction models, radar, and/or the like can be used to predict a location where deposits may accumulate and/or locate an accumulated deposit, for example. As such, the artificial eroding objects 1700 can be employed prior to a deposit having a thickness that could hinder, or otherwise negatively affect, a particular process. Such preventative and/or proactive identification measures can lead to a reduction in maintenance costs and/or process disturbances as it eliminates the need to shut down or isolate a vessel for cleaning, for example. Furthermore, maintaining cleanliness of the vessel can improve equipment lifetime.

The described flow redirecting devices and/or artificial eroding objects provide various benefits over conventional solutions. For example, the described flow redirecting devices and/or artificial eroding objects are able to selectively erode away a deposit without adversely affecting sensitive coating layers within the vessel. Moreover, the described flow redirecting devices and/or artificial eroding objects can be used while the vessel is still active. Stated another way, use of the described flow redirecting devices and/or artificial eroding objects eliminates the need for a process shutdown or unit isolation for deposit removal, as the described flow redirecting devices and/or artificial eroding objects eliminate a need to cool down the process equipment, heater tubes, and/or process lines as well as eliminate a need for a pressure letdown, for example.

The systems disclosed herein can be used to perform a method of removing solid deposits from an inner surface of a vessel. The method includes expanding a flow redirecting device within the vessel, the flow redirecting device including a telescoping mechanism having an inlet telescoping member and an end telescoping member. The inlet telescoping member is an annular wall having a first proximal diameter and a first distal diameter less than the first proximal diameter, and the end telescoping member has an open end and a closed end, the open end having a second proximal diameter less than the first proximal diameter. The telescoping mechanism has a retracted configuration in which the end telescoping member is at least partially nested inside of the inlet telescoping member. The telescoping mechanism has an extended configuration in which the inlet telescoping member and the end telescoping member are arranged end to end to define a flow path that narrows from the first proximal diameter of the inlet telescoping member to the second proximal diameter of the end telescoping member. The end telescoping member has an aperture defined therein, such as in a wall of the end telescoping member, and is in fluid communication with the flow path defined by the inlet telescoping member and has a cross-sectional area that is less than a cross-sectional area of the open end of the end telescoping member. The flow redirecting device further includes an extending arm coupled to the inlet telescoping member and the end telescoping member, wherein the extending arm selectively transitions the telescoping mechanism between the retracted configuration and the extended configuration and a plate coupled to the inlet telescoping member and constructed of a ferromagnetic metal. The method further includes directing the aperture towards the deposit formed on an inner surface of the vessel, disposing one or more eroding objects within the vessel such that the eroding objects enter the fluid flow within the vessel, and redirecting a portion of a fluid and eroding objects flowing through the vessel into the inlet telescoping member and out of the aperture, wherein a shape and size of the end telescoping member relative to the inlet telescoping member causes the fluid to increase in velocity. The method further includes eroding the deposit with a flow out of the aperture.

A first aspect of the present disclosure may be directed to a flow redirecting device comprising a telescoping mechanism. The telescoping mechanism comprises an inlet telescoping member and an end telescoping member. The inlet telescoping member may be an annular wall having a first proximal diameter and a first distal diameter less than the first proximal diameter. The end telescoping member may have an open end and a closed end, the open end having a second proximal diameter less than the first proximal diameter. The telescoping mechanism may have a retracted configuration in which the end telescoping member is nested inside of the inlet telescoping member. The telescoping mechanism may have an extended configuration in which the inlet telescoping member and the end telescoping member are arranged end to end to define a flow path that narrows from the first proximal diameter of the inlet telescoping member to the second proximal diameter of the end telescoping member. The end telescoping member has an aperture defined therein. The aperture is in fluid communication with the flow path defined by the inlet telescoping member and may have a cross-sectional area that is less than a cross-sectional area of the open end of the end telescoping member. The flow redirecting device further comprises an extending arm coupled to the inlet telescoping member and the end telescoping member, wherein the extending arm may be configured to transition the telescoping mechanism between the retracted configuration and the extended configuration. The flow redirecting device may further include a plate coupled to the inlet telescoping member and constructed of a ferromagnetic metal.

A second aspect of the present disclosure may include the first aspect, further comprising at least one intermediate telescoping member. The at least one intermediate telescoping member may be an annular wall having a proximal diameter and a distal diameter less than the proximal diameter. The proximal diameter of the at least one intermediate telescoping member may be less than the first proximal diameter of the inlet telescoping member. The at least one intermediate telescoping member may be slidably disposed between the inlet telescoping member and the end telescoping member. The end telescoping member and the at least one intermediate telescoping member may be nested inside of the inlet telescoping member in the retracted configuration of the telescoping mechanism.

A third aspect of the present disclosure may include either one of the first or second aspects, wherein the inlet telescoping member further may comprise an outer surface, wherein one or more cavities are formed on the outer surface of the inlet telescoping member.

A fourth aspect of the present disclosure may include the third aspect, wherein the one or more cavities may be radially placed ninety-degrees from the plate along the outer surface of the inlet telescoping member.

A fifth aspect of the present disclosure may include any one of the first through fourth aspects, wherein the extending arm may comprise a biasing device comprising one of (1) a spring, (2) a hydraulic actuator, or (3) an electric actuator.

A sixth aspect of the present disclosure may include the fifth aspect, wherein the biasing device may comprise the electric actuator and the flow redirecting device further may comprise a flow sensor coupled to the first telescoping member and communicatively coupled to the electric actuator, wherein when the flow sensor detects a threshold level of fluid flow, the electric actuator may actuate the flow redirecting device into the extended configuration.

A seventh aspect of the present disclosure may include any one of the first through sixth aspects, further comprising a filter covering at least a portion of the inlet telescoping member, wherein the filter may comprise openings that allow fluids to flow through the inlet segment, but prevents particles having a particle size greater than a largest dimension of the openings in the filter from passing into the inlet telescoping member.

An eighth aspect of the present disclosure may include any one of the first through seventh aspects, and may be directed to a system comprising the flow redirecting device of any one of the first through seventh aspects and a magnet separate and independent from the flow redirecting device. The magnet may be removably coupled to the outer surface of the vessel, and the magnet may produce a magnetic field which attracts the ferromagnetic plate such that the flow redirecting device may be removably coupled to the inner surface of the vessel.

A ninth aspect of the present disclosure may include the eighth aspect, further comprising a magnet positioner configured to position the magnet along the outer surface of the vessel.

A tenth aspect of the present disclosure may include the ninth aspect, wherein the magnet positioner may be a robot. The robot may comprise a body; a plurality of magnetic wheels operatively attached to the body, where the plurality of magnetic wheels may be operable to attach the robot to a metal surface of the vessel; and a plurality of propellers coupled to the body.

An eleventh aspect of the present disclosure may include the tenth aspect, further comprising one or more location sensors communicatively coupled to the robot.

A twelfth aspect of the present disclosure may include the eleventh aspect, further comprising a control system communicatively coupled to the robot and the one or more location sensors, where the control system may comprise a processor, at least one memory module communicatively coupled to the processor, and machine readable and executable instructions stored on the at least one memory module, wherein the machine readable and executable instructions, when executed by the processor, may cause the system to automatically: determine the location of one or more regions of deposit buildup within the vessel with the location sensors; and position the robot on the metal surface.

A thirteenth aspect of the present disclosure may include any one of the eighth through twelfth aspects, further comprising a plurality of artificial eroding objects, wherein the plurality of artificial eroding objects may be introduced into the vessel.

A fourteenth aspect of the present disclosure may include the thirteenth aspect, wherein the one or more artificial eroding object may comprise one of: (1) a non-ferromagnetic metal; or (2) sand; or any other particles present within the fluid.

A fifteenth aspect of the present disclosure may be directed to a method for eroding a deposit within a vessel. The method may comprise the step of expanding a flow redirecting device within the vessel. The flow redirecting device may comprise a telescoping mechanism comprising an inlet telescoping member and an end telescoping member. The inlet telescoping member may be an annular wall having a first proximal diameter and a first distal diameter less than the first proximal diameter. The end telescoping member may have an open end and a closed end, wherein the open end may have a second proximal diameter less than the first proximal diameter. The telescoping mechanism may have a retracted configuration in which the end telescoping member is at least partially nested inside of the inlet telescoping member. The telescoping mechanism may have an extended configuration in which the inlet telescoping member and the end telescoping member are arranged end to end to define a flow path that narrows from the first proximal diameter of the inlet telescoping member to the second proximal diameter of the end telescoping member. The end telescoping member may have an aperture defined therein. The aperture may be in fluid communication with the flow path defined by the inlet telescoping member and may have a cross-sectional area that is less than a cross-sectional area of the open end of the end telescoping member. The flow redirecting device may further include an extending arm coupled to the inlet telescoping member and the end telescoping member, wherein the extending arm may selectively transition the telescoping mechanism between the retracted configuration and the extended configuration. The flow redirecting device may further include a plate coupled to the inlet telescoping member and constructed of a ferromagnetic metal. The method may further include directing the aperture towards the deposit formed on an inner surface of the vessel; disposing one or more eroding objects within the vessel such that the eroding objects enter the fluid flow within the vessel; redirecting a portion of a fluid and eroding objects flowing through the vessel into the inlet telescoping member and out of the aperture, wherein a shape and size of the end telescoping member relative to the inlet telescoping member may cause the fluid to increase in velocity; and eroding the deposit with a flow out of the aperture.

A sixteenth aspect of the present disclosure may include the fifteenth aspect, further comprising the step of positioning the flow redirecting device within the vessel with a magnet.

A seventeenth aspect of the present disclosure may include the sixteenth aspect, wherein the magnet may be positioned by a magnet positioner.

An eighteenth aspect of the present disclosure may include the seventeenth aspect, wherein the magnet positioner may be a robot. The robot may comprise a body; a plurality of magnetic wheels operatively attached to the body, where the plurality of magnetic wheels may be operable to attach the robot to a metal surface of the vessel; and a plurality of propellers coupled to the body.

A nineteenth aspect of the present disclosure may include any one of the fifteenth through eighteenth aspects, further comprising the step of rotating the flow redirecting device within the vessel by flowing the fluid within the vessel across one or more cavities formed on an outer surface of the inlet telescoping member.

A twentieth aspect of the present disclosure may include any one of the fifteenth through nineteenth aspects, further comprising the step of flowing a secondary fluid through the inlet telescoping member and out of the aperture.

A twenty-first aspect of the present disclosure may include any one of the fifteenth through twentieth aspects, further comprising filtering the fluid with a filter, where the filter may be positioned adjacent to the inlet telescoping member.

It may be noted that one or more of the following claims utilize the terms “where,” “wherein,” or “in which” as transitional phrases. For the purposes of defining the present technology, it may be noted that these terms are introduced in the claims as an open-ended transitional phrase that are used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it may be noted that the various details described in this disclosure should not be taken to imply that these details relate to elements that are essential components of the various embodiments described in this disclosure, even in cases where a particular element may be illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims

What is claimed is:

1. A flow redirecting device comprising:
a telescoping mechanism comprising:
an inlet telescoping member and an end telescoping member, wherein:
the inlet telescoping member is an annular wall having a first proximal diameter and a first distal diameter less than the first proximal diameter;
the end telescoping member has an open end and a closed end, the open end having a second proximal diameter less than the first proximal diameter;
the telescoping mechanism has a retracted configuration in which the end telescoping member is nested inside of the inlet telescoping member;
the telescoping mechanism has an extended configuration in which the inlet telescoping member and the end telescoping member are arranged end to end to define a flow path that narrows from the first proximal diameter of the inlet telescoping member to the second proximal diameter of the end telescoping member; and
the end telescoping member has an aperture defined therein;
the aperture is in fluid communication with the flow path defined by the inlet telescoping member and has a cross-sectional area that is less than a cross-sectional area of the open end of the end telescoping member;
an extending arm coupled to the inlet telescoping member and the end telescoping member, wherein the extending arm is configured to transition the telescoping mechanism between the retracted configuration and the extended configuration; and
a plate coupled to the inlet telescoping member and constructed of a ferromagnetic metal.

2. The flow redirecting device of claim 1, further comprising:
at least one intermediate telescoping member, where the at least one intermediate telescoping member is an annular wall having a proximal diameter and a distal diameter less than the proximal diameter;
the proximal diameter of the at least one intermediate telescoping member is less than the first proximal diameter of the inlet telescoping member;
the at least one intermediate telescoping member is slidably disposed between the inlet telescoping member and the end telescoping member; and
the end telescoping member and the at least one intermediate telescoping member are nested inside of the inlet telescoping member in the retracted configuration of the telescoping mechanism.

3. The flow redirecting device of claim 1, wherein the inlet telescoping member further comprises an outer surface, wherein one or more cavities are formed on the outer surface of the inlet telescoping member.

4. The flow redirecting device of claim 3, wherein the one or more cavities are radially placed ninety-degrees from the plate along the outer surface of the inlet telescoping member.

5. The flow redirecting device of claim 1, wherein the extending arm comprises a biasing device comprising one of (1) a spring, (2) a hydraulic actuator, or (3) an electric actuator.

6. The flow redirecting device of claim 5, wherein the biasing device comprises the electric actuator and the flow redirecting device further comprises a flow sensor coupled to the first telescoping member and communicatively coupled to the electric actuator, wherein when the flow sensor detects a threshold level of fluid flow, the electric actuator actuates the flow redirecting device into the extended configuration.

7. The flow redirecting device of claim 1, further comprising a filter covering at least a portion of the inlet telescoping member, wherein the filter comprises openings that allow fluids to flow through the inlet segment, but prevents particles having a particle size greater than a largest dimension of the openings in the filter from passing into the inlet telescoping member.

8. A system comprising the flow redirecting device of claim 1 and a magnet separate and independent from the flow redirecting device, wherein the magnet is removably coupled to the outer surface of the vessel and the magnet produces a magnetic field which attracts the ferromagnetic plate such that the flow redirecting device is removably coupled to the inner surface of the vessel.

9. The system of claim 8, further comprising a magnet positioner configured to position the magnet along the outer surface of the vessel.

10. The system of claim 9, wherein the magnet positioner is a robot, the robot comprising:
a body;
a plurality of magnetic wheels operatively attached to the body, where the plurality of magnetic wheels are operable to attach the robot to a metal surface of the vessel; and
a plurality of propellers coupled to the body.

11. The system of claim 9, further comprising one or more location sensors communicatively coupled to the robot.

12. The system of claim 11, further comprising:
a control system communicatively coupled to the robot and the one or more location sensors, where the control system comprises a processor, at least one memory module communicatively coupled to the processor, and machine readable and executable instructions stored on the at least one memory module, wherein the machine readable and executable instructions, when executed by the processor, cause the system to automatically:
determine the location of one or more regions of deposit buildup within the vessel with the location sensors; and
position the robot on the metal surface.

13. The system of claim 8, further comprising a plurality of artificial eroding objects, the plurality of artificial eroding objects introduced into the vessel.

14. The system of claim 13, wherein the one or more artificial eroding object comprises one of: (1) a non-ferromagnetic metal; or (2) sand.

15. A method for eroding a deposit within a vessel, the method comprising the steps of:
expanding a flow redirecting device within the vessel, the flow redirecting device comprising:
a telescoping mechanism comprising an inlet telescoping member and an end telescoping member, wherein:
the inlet telescoping member is an annular wall having a first proximal diameter and a first distal diameter less than the first proximal diameter;
the end telescoping member has an open end and a closed end, the open end having a second proximal diameter less than the first proximal diameter;
the telescoping mechanism has a retracted configuration in which the end telescoping member is at least partially nested inside of the inlet telescoping member;
the telescoping mechanism has an extended configuration in which the inlet telescoping member and the end telescoping member are arranged end to end to define a flow path that narrows from the first proximal diameter of the inlet telescoping member to the second proximal diameter of the end telescoping member; and
the end telescoping member has an aperture defined therein, wherein the aperture is in fluid communication with the flow path defined by the inlet telescoping member and has a cross-sectional area that is less than a cross-sectional area of the open end of the end telescoping member;
an extending arm coupled to the inlet telescoping member and the end telescoping member, wherein the extending arm selectively transitions the telescoping mechanism between the retracted configuration and the extended configuration; and
a plate coupled to the inlet telescoping member and constructed of a ferromagnetic metal;
directing the aperture towards the deposit formed on an inner surface of the vessel;
disposing one or more eroding objects within the vessel such that the eroding objects enter the fluid flow within the vessel;
redirecting a portion of a fluid and eroding objects flowing through the vessel into the inlet telescoping member and out of the aperture, wherein a shape and size of the end telescoping member relative to the inlet telescoping member causes the fluid to increase in velocity; and
eroding the deposit with a flow out of the aperture.

16. The method of claim 15, further comprising the step of positioning the flow redirecting device within the vessel with a magnet.

17. The method of claim 16, wherein the magnet is positioned by a magnet positioner.

18. The method of claim 17, wherein the magnet positioner is a robot, the robot comprising:
a body;
a plurality of magnetic wheels operatively attached to the body, where the plurality of magnetic wheels are operable to attach the robot to a metal surface of the vessel; and
a plurality of propellers coupled to the body.

19. The method of claim 15, further comprising the step of rotating the flow redirecting device within the vessel by flowing the fluid within the vessel across one or more cavities formed on an outer surface of the inlet telescoping member.

20. The method of claim 15, further comprising filtering the fluid with a filter, where the filter is positioned adjacent to the inlet telescoping member.
